(19) United States
(12) Patent Application Publication
(10) Pub. No.: US 2013/0223629 A1
(43) Pub. Date: Aug. 29, 2013

(54) METHOD OF SECURE KEY EXCHANGE IN WIRELESS/WIRED ENVIRONMENTS

(71) Applicants: YI-LI HUANG, Taichung City (TW); FANG-YIE LEU, Taichung City (TW)

(72) Inventors: YI-LI HUANG, Taichung City (TW); FANG-YIE LEU, Taichung City (TW)

(21) Appl. No.: 13/404,524

(22) Filed: Feb. 24, 2012

(51) Int. Cl. H04L 9/08

(52) U.S. Cl. 380/278

(57) ABSTRACT

A method of safe key exchange in wireless/wired environment prevents communication messages from being intercepted or sniffed by hackers. The method includes a public key protection technique based on the combination of RSA and Diffie-Hellman PKDS, a binary operation key protection technique, and a multivariable operation key protection technique. The method allows both parties of wireless/wired communication use these three techniques alternately to create linked key groups between both parties and thereby effectively and efficiently ensure the safety of subsequent communication.

### FIELD OF THE INVENTION

The present invention is a secure key exchange method in wireless/wired environments. More preciously, it is a method that comprises a binary operation key protection technique, a multivariable operation key protection technique, and a public key protection technique based on the integration of the RSA and the Diffie-Hellman PKDS.

### BACKGROUND OF THE INVENTION

In wireless/wired communication, security of key exchange between both parties for their communication is of vital importance. At the beginning of a communication, messages delivered between the two parties are encrypted with random variables that serve as dynamic keys. The purpose is to ensure that the communication can be securely performed.

From the early GSM system to the developing LTE and the WiMAX system in use, when communication begins, the system end first chooses a random variable as the dynamic key with which to generate the extending linked keys, and then the dynamic key and the extending linked keys are sent to the user end. For example, in GSM, the system end (HLR) generates a random number RAND, and employs A₃ and A₈ functions which in return invoke the RAND and user's individual key Kᵢ as the inputs to compute the dynamic extending linked keys SRES and K_{c}. After that it sends the RAND, SRES and K_{c} to the user end.

In LTE, the system end (AuC/HSS) performs computation on UE Security key K and the random variable RAND to generate dynamic keys CK, IK, XRES and AUTN, and then sends these dynamic keys to the user end.

In WiMAX PKMv1, the system end (base station) encrypts a random variable AK, generated by the base station, by using RSA public key (PubKey(SS)) issued by the user end, and then sends the encrypted random variable to the user end for use therein. In the WiMAX PKMv2, RSA-based authorization process creates a random variable pre_AK for the system end (ASN), encrypting it with RSA, sending the encrypted pre_AK to the user end, deriving dynamic keys EIK and PAK from pre_AK, and eventually protecting subsequent EAP messages with the EIK.

### SUMMARY OF THE INVENTION

In the aforesaid wireless/wired communication system, random variables are always generated by the system end at the beginning of communication. However, the system end has to serve a plurality of users. If at the beginning of communication, random variables are first generated by the user end, and then other random variables are generated by the system end, the randomness of the random variables will be higher than the case in which the first random variable is generated by the system end, thereby encumbering decryption and enhancing safety. Furthermore, at the beginning of communication, new random variables are always generated on each message exchange, and the new random variables can form the linked key groups for use at the user end and the system end in operating a safe protection mechanism for later transmitted messages between the two ends so as to enhance the safety of the communication system greatly. The present invention provides methods of safe key exchange to address the aforesaid feature and enable random variables to be generated on the user end and the system end during their communication.

The present invention employs functions as follows:
1. Diffie-Hellman PKDS Function in which
DH(x,p,g)=g^{x} mod p, where p is a strong prime, g is a primitive root of p, and x is a random variable, wherein DH(x,p,g), p and x are of the same length, i.e., 128, 256, 512, 1024 or 2048 bits.

### 2. Exclusive OR Function

Encryption: EXOR(x,y)=x⊕y
Decryption: y=x⊕EXOR(x,y)

### 3. Exclusive AND Function

Encryption: EXAND(x,y)=x⊙y
Decryption: y=x⊙EXAND(x,y)

### 4. Binary ADD Function

Encryption: ADD(x,y)=x+y, where “+” is a binary adder which discards the carry of the most significant bits of x+y
Decryption: y=ADD(x,y)−x, if ADD(x,y)≧x
   y=ADD(x,y)+ x̅+1, if ADD(x,y)<x

### 5. Data Transmission Function

Encryption: Datfun(a,b,c)=(a⊕b)+c, where key a is the transmitted key and keys b and c are known by both the sender and receiver beforehand.
Decryption: a=(Datfun(a,b,c)−c)⊕b, if Datfun(a,b,c)≧c
   a=(Datfun(a,b,c)+ c̅+1)⊕b, if Datfun(a,b,c)<c

### 6. RSA Encryption/Decryption Function

Encryption: RSA−En(m,e)=m^{e} mod N, where m is the message to be delivered and (e,N) is the RSA public key
Decryption: RSA−De(RSA−En(m,e),d)=RSA−En(m,e)^{d} mod N, where (d,N) is the RSA private key
   The present invention relates to three protection techniques as follows:
1. Public Key Protection Technique Based on Combination of RSA and Diffie-Hellman PKDS.
   First, the sender (party A) sends its RSA public key (e_{A}, N_{A}) and public key Yₐ of Diffie-Hellman PKDS to the receiver (party B). Then, party B encrypts Y_{b} (party B's public key of Diffie-Hellman PKDS) by (e_{A}, N_{A}) and sends the encrypted Y_{b} to party A. In doing so, Y_{b} receives complete and safe protection, and in consequence the common secret key CSK₁ to be generated by both parties will be safer.
2. Binary Operation Key Protection Technique
   The binary operation key protection technique is about computation performed on protected message with two different dynamic keys and two different operators. Assuming that key a is a message to be protected, while key b and key c are dynamic linked keys in the possession of both parties to communication. Party A then sends Datfun(a,b,c) to party B, such that key a receives dual protection of key b and key c to thereby effectuate transmission safety.
3. Multivariable Operation Key Protection Technique
   The multivariable operation key protection technique is about computation performed on protected message with three or more other dynamic keys, and two or more operators. Assuming that key x is a message unit to be protected and keys a, b, c and d are dynamic linked keys. Party A then sends the encrypted key y to party B, where y=((x⊕a)+b)⊙(c+d), and in consequence key x receives highly safe protection.

### BRIEF DESCRIPTION OF THE DRAWINGS

Objectives, features, and advantages of the present invention are hereunder illustrated with a specific embodiment in conjunction with the accompanying drawings, in which:

FIG. 1 is a flow chart of a specific embodiment of the present invention.

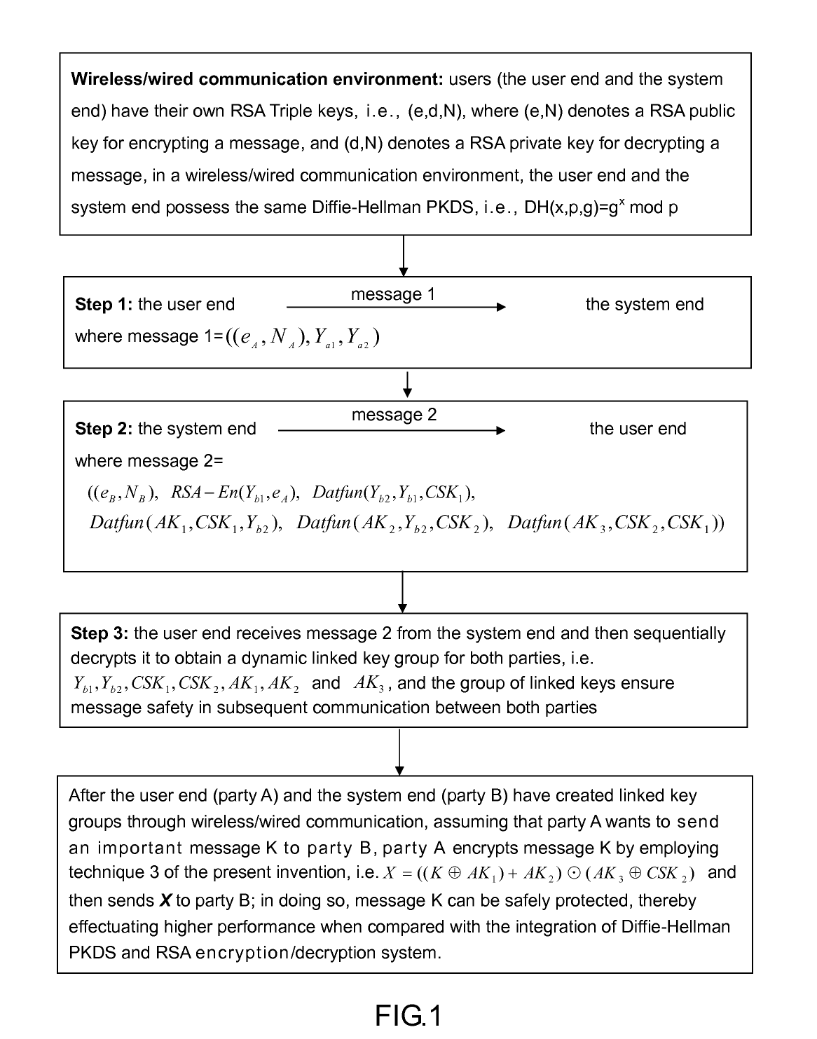

### DETAILED DESCRIPTION OF THE PREFERRED EMBODIMENTS

According to the present invention, a wireless/wired environment dispenses with a certification authority (CA), but users (the user end and the system end) have their own RSA Triple keys, i.e., (e,d,N), where (e,N) is a RSA public key for encrypting message, and (d,N) is a RSA private key for decrypting message. In the wireless/wired communication environment, the user end and the system end process the same Diffie-Hellman PKDS, i.e., DH(x,p,g)=g^{x} mod p. The user end (party A) and the system end (party B) create linked key groups through wireless/wired links by following the steps of:

Step 1: The user end (party A) executes the following tasks:
(a) generating two random variables Xₐ₁ and Xₐ₂ for serving as private keys of Diffie-Hellman PKDS;
(b) generating corresponding public keys Yₐ₁ and Yₐ₂ of Diffie-Hellman PKDS, where Yₐⱼ=g^{x}^{ₐⱼ} mod p, j=1,2;
(c) sending message 1, ((e_{A}, N_{A}), Yₐ₁, Yₐ₂), to the system end (party B), where the number of the public keys of Diffie-Hellman PKDS in message 1 is two, but is not limited thereto, as it is also feasible to have one, two, or more than two public keys of Diffie-Hellman PKDS in message 1;
Step 2: On receiving message 1, the system end (party B) executes the following tasks:
(a) retrieving random variables X_{b1} and X_{b2} from a pre-established internal random variables table to serve as its private keys, calculating the corresponding public keys Y_{b1} and Y_{b2}, respectively, and then retrieving three random variables AK₁, AK₂, and AK₃ also from the variables table;
(b) encrypting Y_{b1} with (e_{A}, N_{A}) carried in message1 issued by party A by using the equation below

RSA−En(Y_{b1},e_{A})=Y_{b1}^{e}^{_{A}} mod N_{A};

(c) calculating both parties' common secret key CSKⱼ, where

CSKⱼ=Yₐⱼ^{X}^{_{bj}} mod p,1≦j≦2;

(d) sending message 2, that is,
((e_{B}, N_{B}), RSA−En(Y_{b1}, e_{A}), Datfun(Y_{b2}, Y_{b1}, CSK₁), Datfun(AK₁, CSK₁, Y_{b2}), Datfun(AK₂, Y_{b2}, CSK₂), Datfun(AK₃, CSK₂, CSK₁)) to party A, where the number of data transmission functions (Datfun( )) in message 2 is four, but is not limited thereto, as it is also feasible to have one, two, three, four or more data transmission functions (Datfun( )) in message 2, depending on the number of random keys to be encrypted;
Step 3: On receiving message 2 issued by party B, the user end (party A) executes the following tasks:
(a) decryption: Y_{b1}=RSA−En(Y_{b1}, e_{A})^{d}^{_{A}} mod N_{A}; Now the key exchange by using the public key protection technique which combines RSA and Diffie-Hellman PKDS has been completed;
(b) computation: CSK₁=Y_{b1}^{X}^{ₐ₁} mod p;
(c) decryption: let DAT=Datfun(Y_{b2}, Y_{b1}, CSK₁), where

$${Y}_{b 2} = \{ \begin{matrix}( D A T - C S {K}_{1} ) ⊕ {Y}_{b 1} , & if D A T \geq C S {K}_{1} \\ ( D A T + C S {K}_{1} + 1 ) ⊕ {Y}_{b 1} , & if D A T < C S {K}_{1} ;\end{matrix}$$

Now the key exchange by employing the binary operation key protection technique has been completed;
(d) generating CSK₂=Y_{b2}^{X}^{ₐ₂} mod p;
(e) decrypting AK₁, AK₂, and AK₃ in sequence by using the same technique described in (c).
Since Y can only be decrypted by party A who possesses private key (d_{A}, N_{A}), implying that Y_{b1} is safely protected, hackers are unable to figure out Y_{b1}. Even if a hacker figures out Xₐ₁ from Yₐ₁, s/he cannot derive CSK₁; i.e., CSK₁ receives RSA and Diffie-Hellman PKDS dual protection and is much safer than either one. Furthermore, it is unlikely that hackers can figure out Y_{b2} without Y_{b1} and CSK₁, and thus Y_{b2} is safe. By analogy, CSK₂, AK₁, AK₂ and AK₃ are safe.
Technique 1 and technique 2 of the present invention apply to an instance of roundtrip communication between the user end and the system end in sequence, and in consequence safe linked key groups, such as Y_{b1}, Y_{b2}, CSK₁, CSK₂, AK₁, AK₂, and AK₃, are then generated between both parties. The linked key groups ensure message safety for subsequent communication between the two ends. When the user end (party A) wants to create linked key groups between the user end (party A) and the system end (party B) by wireless/wired communication, on receiving message 2 ((e_{B}, N_{B}), RSA−En(Y_{b1}, e_{A}), Datfun(Y_{b2}, Y_{b1}, CSK), Datfun(AK₁, CSK₁, Y_{b2}), Datfun(AK₂, Y_{b2}, CSK₂), Datfun(AK₃, CSK₂, CSK₁)) issued by the system end, party A decrypts RSA−En(Y_{b1}, e_{A}) to obtain Y_{b1}, calculates common secret key CSK₁ by employing Y_{b1} and its own private key Xₐ₁, decrypts Datfun(Y_{b2}, Y_{b1}, CSK₁) by using Y_{b1} and CSK₁ to obtain Y_{b2}, calculates common secret key CSK₂ by invoking Y_{b2} and its own private key Xₐ₂, decrypts Datfun(AK₁, CSK₁, Y_{b2}) by CSK₁ and Y_{b2} to acquire AK₁, decrypts Datfun(AK₂, Y_{b2}, CSK₂) by using Y_{b2} and CSK₂ to obtain AK₂, and decrypts Datfun(AK₃, CSK₂, CSK₁) by CSK₂ and CSK₁ to obtain AK₃. In doing so, two dynamic linked keys Y_{b1} and CSK₁ undergo encryption/transmission/decryption to obtain a new dynamic linked key Y_{b2}, and then sequentially extend the dynamic linked keys safely results in a new dynamic linked key group, i.e., Y_{b1}, Y_{b2}, CSK₁, CSK₂, AK₁, AK₂ and AK₃, which represents an important contribution of the present invention.
In a wireless/wired communication system, a random variable is generated by the system end at the beginning of communication. However, the system end has to serve a plurality of users. If at the beginning of communication, random variables are generated by the user end and other random variables are generated by the system end, the randomness of the random variables will be higher than the case in which the first random variable is generated by the system end, thereby encumbering decryption and enhancing safety. In step 1 of the present invention, random variables Yₐ₁ and Yₐ₂ are generated by the user end, and then random variables Y_{b1}, Y_{b2}, AK₁, AK₂ and AK₃ are produced by the system end; hence, after an instance of roundtrip message transmission, both parties possess seven dynamic linked keys, namely Y_{b1}, Y_{b2}, CSK₁, CSK₂, AK₁, AK₂ and AK₃ with which both parties encrypt delivered messages and messages in the subsequent communication, so that communication can be safely performed.
Assuming that party A wants to send an important message K to party B, party A can employ two safe transmission techniques as follows:
Technique 1: encrypting message K with party B's RSA public key (e_{B}, N_{B}), that is, RSA−En(K, e_{B})=K^{e}^{_{B}} mod N_{B}, and then sending RSA−En(K, e_{B}) to party B;
Technique 2: encrypting message K with the multivariable operation key protection technique, that is, X=((K⊕AK₁)+AK₂)⊙(AK₃⊕CSK₂), and then sending X to party B. With this technique, message K can be safely protected, thereby effectuating higher performance when compared with the RSA encryption/decryption system.
In technique 2, message K is encrypted by the multivariable operation keys protection technique. This technique is performed on protected message key, by using three or more dynamic keys, and two or more operators.
Although both the two aforesaid techniques protect the message K, technique 2 excels technique 1 in speed and thus in performance.

What is claimed is:

1. A method of safe key exchange in wireless/wired environment, a user end (party A) and a system end (party B) create linked key groups therebetween by wireless/wired communication, and users (the user end and the system end) have their own RSA Triple keys, i.e., (e,d,N), where (e,N) denotes a RSA public key for encrypting a message, and (d,N) denotes a RSA private key for decrypting a message such that, in the wireless/wired communication environment, the same Diffie-Hellman PKDS, i.e., DH(x,p,g)=g^{x} mod p, is processed at the user end and the system end, wherein the user end (party A) and the system end (party B) create linked key groups through wireless/wired links by following the steps of:
Step 1: the user end (party A) executes the following tasks:
(a) generating two random variables Xₐ₁ and Xₐ₂ for serving as private keys of Diffie-Hellman PKDS;
(b) generating corresponding public keys Yₐ₁ and Yₐ₂ of Diffie-Hellman PKDS, where Yₐⱼ=g^{X}^{ₐⱼ} mod p, j=1,2;
(c) sending message 1, ((e_{A}, N_{A}), Yₐ₁, Yₐ₂), to the system end (party B), where the number of the public keys of Diffie-Hellman PKDS in message 1 is two, but is not limited thereto, as it is also feasible to have one, two, or more than two public keys of Diffie-Hellman PKDS in message 1;
Step 2: On receiving message 1, the system end (party B) executes the following tasks:
(a) retrieving random variables X_{b1} and X_{b2} from a pre-established internal random variables table to serve as its private keys, calculating the corresponding public keys Y_{b1} and Y_{b2}, respectively, and then retrieving three random variables AK₁, AK₂, and AK₃ also from the random variables table;
(b) encrypting Y_{b1} with (e_{A}, N_{A}) carried in message1 in party A by using the equation below
RSA−En(Y_{b1},e_{A})=Y_{b1}^{e}^{_{A}} mod N_{A};
(c) calculating both parties' common secret key CSKⱼ, where
CSKⱼ=Yₐⱼ^{X}^{_{bj}} mod p,1≦j≦2;
(d) sending message 2, that is,
((e_{B}, N_{B}), RSA−En(Y_{b1}, e_{A}), Datfun(Y_{b2}, Y_{b1}, CSK₁), Datfun(AK₁, CSK₁, Y_{b2}), Datfun(AK₂, Y_{b2}, CSK₂), Datfun(AK₃, CSK₂, CSK₁))
to party A, where the number of data transmission functions (Datfun( )) in message 2 is four, but is not limited thereto, as it is also feasible to have one, two, three, four or more data transmission functions (Datfun( )) in message 2, depending on the number of random keys to be encrypted;
Step 3: On receiving message 2 issued by party B, the user end (party A) executes the following tasks:
(a) decryption: Y_{b1}=RSA−En(Y_{b1}, e_{A})^{d}^{_{A}} mod N_{A}; Now the key exchange by using the public key protection technique which combines RSA and Diffie-Hellman PKDS has been completed;
(b) computation: CSK₁=Y_{b1}^{X}^{ₐ₁} mod p;
(c) decryption: let DAT=Datfun(Y_{b2}, Y_{b1}, CSK₁), where
$${Y}_{b 2} = \{ \begin{matrix}( D A T - C S {K}_{1} ) ⊕ {Y}_{b 1} , & if D A T \geq C S {K}_{1} \\ ( D A T + C S {K}_{1} + 1 ) ⊕ {Y}_{b 1} , & if D A T < C S {K}_{1} ;\end{matrix}$$
now the key exchange by employing the binary operation key protection technique has been completed;
(d) generating CSK₂=Y_{b2}^{X}^{ₐ₂} mod p;
(e) decrypting AK₁, AK₂, and AK₃ in sequence by using the same technique described in (c).
At this point in time, both parties, the user end and the system end, finalize dynamic linked key groups, i.e., Y_{b1}, Y_{b2}, CSK₁, CSK₂, AK₁, AK₂, AK₃, and the linked key groups ensure message safety of both parties to subsequent communication;
assuming that party A wants to send an important message K to party B, party A can employ two safe transmission techniques as follows:
technique 1: encrypting message K with party B's RSA public key (e_{B}, N_{B}), that is, RSA−En(K, e_{B})=K^{e}^{_{B}} mod N_{B}, and then sending RSA−En(K, e_{B}) to party B;
technique 2: encrypting message K with the multivariable operation key protection technique, that is, X=((K⊕AK₁)+AK₂)⊙(AK₃⊕CSK₂), and then sending X to party B; wherein, although both the two aforesaid techniques protect message K, technique 2 excels technique 1 in speed and thus in performance.

2. The method of claim 1, wherein users (the user end and the system end) have their own RSA Triple keys, that is, (e,d,N), where (e,N) denotes a RSA public key for encrypting a message, and (d,N) denotes a RSA private key for decrypting a message such that, in the wireless/wired communication environment, the same Diffie-Hellman PKDS, i.e., DH(x,p,g)=g^{x} mod p, is processed at the user end and the system end.

3. The method of claim 1, wherein party A sends message K to party B by two transmission techniques:
technique 1: encrypting message K with party B's RSA public key (e_{B}, N_{B}), i.e., RSA−En(K, e_{B})=K^{e}^{_{B}} mod N_{B}, and then sending RSA−En(K, e_{B}) to party B;
technique 2: encrypting message K with the multivariable operation key protection technique, i.e., X=((K⊕AK₁)+AK₂)⊙(AK₃⊕CSK₂), and then sending X to party B, wherein the multivariable operation key protection technique is performed on a protected message key with three or more dynamic keys, and two or more operators.

4. The method of claim 1, wherein, when the user end (party A) wants to create linked key groups between the user end (party A) and the system end (party B) by wireless/wired communication, on receiving message 2 ((e_{B}, N_{B}), RSA−En(Y_{b1}, e_{A}), Datfun(Y_{b2}, Y_{b1}, CSK₁), Datfun(AK₁, CSK₁, Y_{b2}), Datfun(AK₂, Y_{b2}, CSK₂), Datfun(AK₃, CSK₂, CSK₁)) issued by the system end, party A decrypts RSA−En(Y_{b1}, e_{A}) to obtain Y_{b1}, calculates common secret key CSK₁ by employing Y_{b1} and its own private key Xₐ₁, decrypts Datfun(Y_{b2}, Y_{b1}, CSK₁) by using Y_{b1} and CSK₁ to obtain Y_{b2}, calculates common secret key CSK₂ by invoking Y_{b2} and its own private key Xₐ₂, decrypts Datfun(AK₁, CSK₁, Y_{b2}) by CSK₁ and Y_{b2} to acquire AK₁, decrypts Datfun(AK₂, Y_{b2}, CSK₂) by using Y_{b2} and CSK₂ to obtain AK₂, and decrypts Datfun(AK₃, CSK₂, CSK₁) by CSK₂ and CSK₁ to obtain AK₃. In doing so, two dynamic linked keys Y_{b1} and CSK₁ undergo encryption/transmission/decryption to obtain a new dynamic linked key Y_{b2}, and then sequentially extend the dynamic linked keys safely results in a new dynamic linked key group, i.e., Y_{b1}, Y_{b2}, CSK₁, CSK₂, AK₁, AK₂ and AK₃.

5. The method of claim 1, wherein, in step 1, random variables Yₐ₁ and Yₐ₂ are generated by the user end, and then random variables Y_{b1}, Y_{b2}, AK₁, AK₂ and AK₃ are produced by the system end; hence, after an instance of roundtrip message transmission, both parties possess seven dynamic linked keys, namely Y_{b1}, Y_{b2}, CSK₁, CSK₂, AK₁, AK₂ and AK₃ with which both parties encrypt delivered messages and messages in the subsequent communication so that communication can be safely performed.

6. The method of claim 1, wherein, assuming that party A wants to send an important message K to party B, party A can employ two safe transmission techniques as follows:
technique 1: encrypting message K with party B's RSA public key (e_{B}, N_{B}), that is, RSA−En(K, e_{B})=K^{e}^{_{B}} mod N_{B}, and then sending RSA−En(K, e_{B}) to party B;
technique 2: encrypting message K with the multivariable operation key protection technique, that is, X=((K⊕AK₁)+AK₂)⊙(AK₃⊕CSK₂), and then sending X to party B; wherein, although both the two aforesaid techniques protect message K, technique 2 excels technique 1 in speed and thus in performance.
